(19) United States
(12) Patent Application Publication
(10) Pub. No.: US 2019/0043294 A1
(43) Pub. Date: Feb. 7, 2019

(54) INTELLIGENT DOOR CONTROLLER AND AUTOMATED SECURITY ATTENDANT

(71) Applicant: Intel Corporation, Santa Clara, CA (US)

(72) Inventor: Jeff Runyon, Queen Creek, AZ (US)

(73) Assignee: Intel Corporation, Santa Clara, CA (US)

(21) Appl. No.: 15/987,006

(22) Filed: May 23, 2018

Related U.S. Application Data
(60) Provisional application No. 62/558,576, filed on Sep. 14, 2017.

(51) Int. Cl. G07C 9/00; G06F 21/32

(52) U.S. Cl. CPC G07C 9/00563; G06F 21/32

(57) ABSTRACT

Systems, apparatuses and methods may provide for a door control subsystem that includes an energy harvester and power storage to provide standalone power to the door control system, a lock control, lock mechanism, contact, and a security subsystem coupled to the lock control. The security subsystem may conduct a user authentication and selectively activate the lock control based on a result of the user authentication. Other embodiments are disclosed and claimed.

### CROSS-REFERENCE TO RELATED APPLICATIONS

This application claims benefit of U.S. Provisional Patent Application No. 62/558,876 filed Sep. 14, 2017.

### TECHNICAL FIELD

Embodiments generally relate to security systems. More particularly, embodiments relate to an intelligent door controller and an automated security attendant.

### BACKGROUND

Traditional card reader controllers require a hardwired infrastructure and data gathering panels making installation costs very high at about $5K per door. For example, commercial access control system generally require cabling and a power source. Additionally, some hardwired card reader controllers utilize ARM architecture, and do not have a liquid crystal display (LCD) screen or camera. Conventional card reader controllers require an external power source and custom development to integrate through a complex software development kit (SDK).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a door control system according to an embodiment;

FIG. 2 is a block diagram of an example of a door controller apparatus according to an embodiment;

FIGS. 3A to 3D are flowcharts of an example of a method of controlling a door according to an embodiment;

FIG. 4 is a block diagram of another example of a door control system according to an embodiment;

FIG. 5 is a flowchart of an example of a method of operating a security subsystem according to an embodiment;

FIG. 6 is a block diagram of an example of an automated security attendant system according to an embodiment;

FIG. 7 is a block diagram of an example of a semiconductor package apparatus according to an embodiment;

FIG. 8 is a flowchart of an example of a method of automatically attending to security screening according to an embodiment;

FIG. 9 is a perspective view of an automated security attendant according to an embodiment;

FIG. 10 is an illustrative diagram of a user interface according to an embodiment;

FIG. 11 is a block diagram of an example of a computing device according to an embodiment;

FIG. 12 is a block diagram of an example of a processor according to an embodiment; and

FIG. 13 is a block diagram of an example of a computing system according to an embodiment.

### DESCRIPTION OF EMBODIMENTS

Intelligent Door Controller Examples

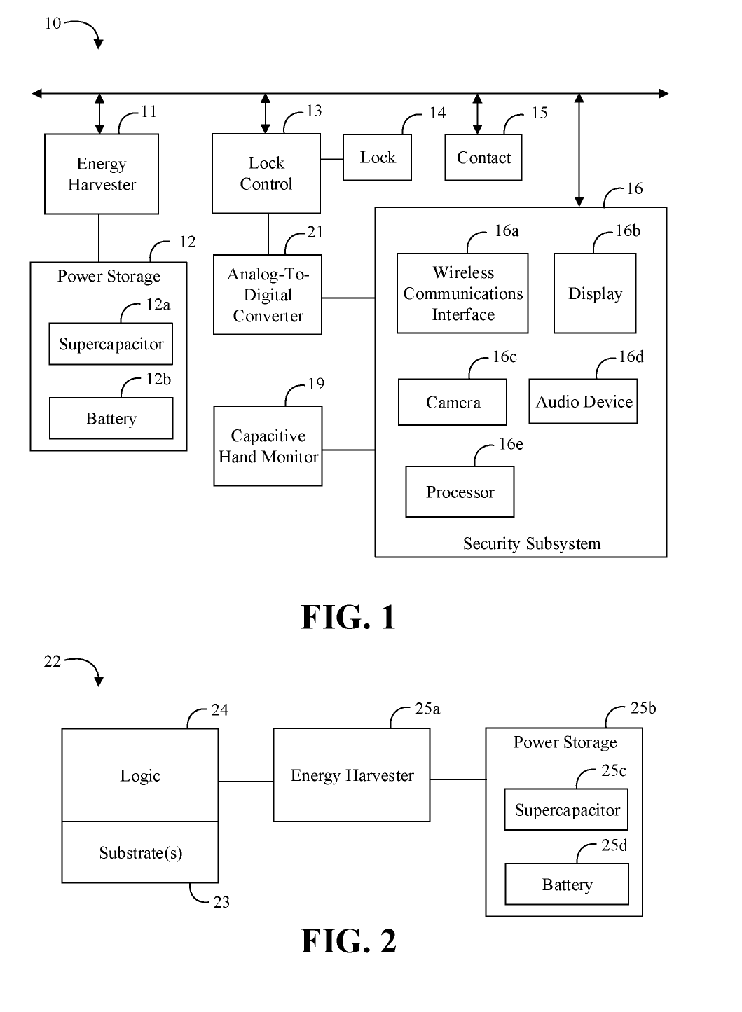

Turning now to FIG. 1, an embodiment of a door control system 10 may include an energy harvester 11 and power storage 12 to provide standalone power to the door control system 10, a lock control 13 (e.g., a relay or other lock control mechanism) to control a lock 14 (e.g., a latch or other lock mechanism), a contact 15 to determine the state of the door (e.g., open or closed), and a security subsystem 16 coupled to the lock control 13, the security subsystem 16 to conduct a user authentication and selectively activate the lock control 13 based on a result of the user authentication. For example, the security subsystem may include a wireless communications interface 16a to receive authentication input, a display 16b to visually present information associated with the user authentication, a camera 16c to capture one or more images, an audio device 16d to capture audio input, and a processor 16e to generate the result based on one or more of the authentication input, the one or more images or the audio input. For example, the wireless communications interface may include one or more of a WIFI radio, a cellular radio, a BLUETOOTH radio, Near Field Communication (NFC) technology, and SMART CARD technology. In some embodiments, the power storage 12 may include one or more of a supercapacitor 12a and a battery 12c coupled to the energy harvester 11. The system 10 may further include an analog-to-digital converter 17 coupled to the lock control 13 and the security subsystem 16. In some embodiments, various of the system components may be located in, or co-located with, various other components, including the processor 16e (e.g., on a same die).

In some embodiments, the system 10 may further include a capacitive hand monitor 18 coupled to the security subsystem 16 to facilitate an exit process without generating a door forced open alarm, where the security subsystem 16 may include technology to selectively activate the lock control 13 further based on a state of the capacitive hand monitor 18.

Embodiments of each of the above energy harvester 11, power storage 12, lock control 13, lock mechanism 14, contact 15, security subsystem 16, wireless communications interface 16a, display 16b, camera 16c, audio device 16d, processor 16e capacitive hand monitor 18, supercapacitor 12a, battery 12b, analog-to-digital converter 19, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, persistent storage media or other system memory may store a set of instructions which when executed by the processor 16e cause the system 10 to implement one or more components, features, or aspects of the system 10 (e.g., the security subsystem 13, conducting the user authentication, selectively activating the lock control, etc.).

Turning now to FIG. 2, an embodiment of a door controller apparatus 22 may include an energy harvester 25a and power storage 25b to provide power, one or more substrates 23, and logic 24 coupled to the one or more substrates 23 and the power storage 25b, where the logic 24 is at least partly implemented in one or more of configurable logic and fixed-functionality hardware logic. The logic 24 coupled to the one or more substrates 23 may be configured to conduct a user authentication, and selectively activate a lock control based on a result of the user authentication. In some embodiments, the logic 24 may be further configured to provide a wireless communications interface to receive authentication input, visually present information associated with the user authentication on a display, capture one or more images from a camera, capture audio input from an audio device, and generate the result based on one or more of the authentication input, the one or more images, and the audio input. For example, the wireless communications interface may include one or more of a WIFI radio, a cellular radio, a BLUETOOTH radio, NFC technology, and SMART CARD technology. In some embodiments of the apparatus 22, the power storage 25b may include one or more of a supercapacitor 25c and a battery 25d coupled to the energy harvester 25a. The logic 24 may also be configured to convert an analog signal to a digital signal to selectively activate the lock control, and/or monitor the door status switch and other analog end points.

In some embodiments, the logic 24 may be further configured to selectively activate the lock control further based on a state of a capacitive hand monitor to facilitate an exit process without generating a door forced open alarm. In some embodiments, the logic 24 coupled to the one or more substrates 23 may include transistor channel regions that are positioned within the one or more substrates 23.

Embodiments of logic 24, and other components of the apparatus 22, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

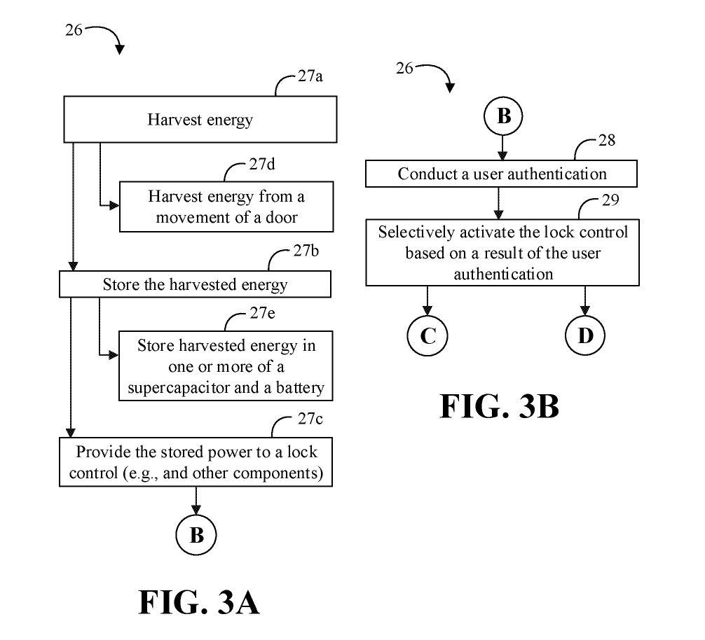

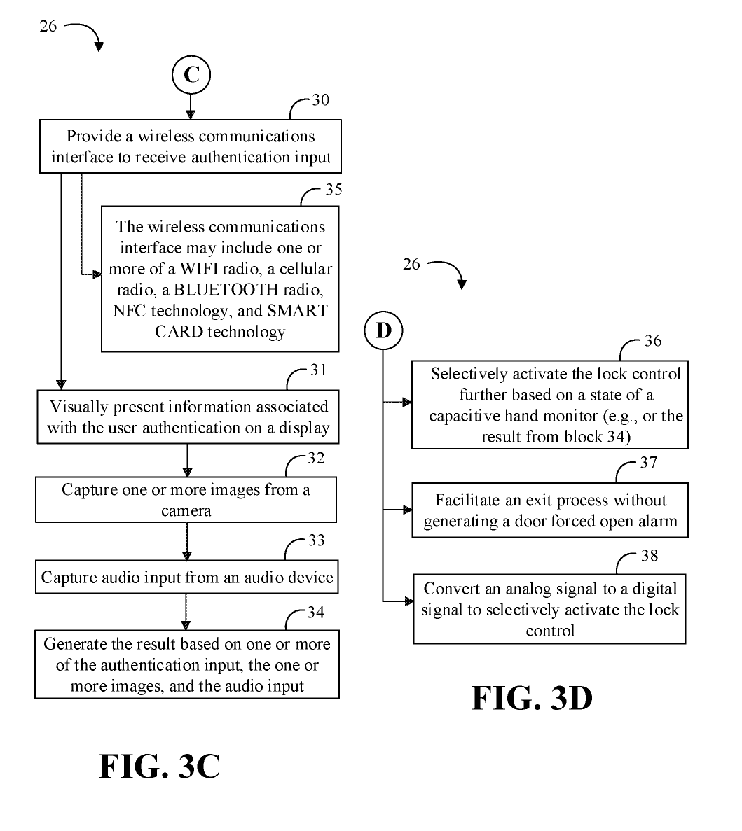

The apparatus 22 may implement one or more aspects of the method 26 (FIGS. 3A to 3D), or any of the embodiments discussed herein. In some embodiments, the illustrated apparatus 22 may include the one or more substrates 23 (e.g., silicon, sapphire, gallium arsenide) and the logic 24 (e.g., transistor array and other integrated circuit/IC components) coupled to the substrate(s) 23. The logic 24 may be implemented at least partly in configurable logic or fixed-functionality logic hardware. In one example, the logic 24 may include transistor channel regions that are positioned (e.g., embedded) within the substrate(s) 23. Thus, the interface between the logic 24 and the substrate(s) 23 may not be an abrupt junction. The logic 24 may also be considered to include an epitaxial layer that is grown on an initial wafer of the substrate(s) 23.

Turning now to FIGS. 3A to 3D, an embodiment of a method 26 of controlling a door may include harvesting energy at block 27a, storing harvested energy at block 27b, and providing stored power to a lock control at block 27c (e.g., and other components). For example, the method 26 may include harvesting energy from a movement of a door at block 27d. For example, the method 26 may include storing harvested energy in one or more of a supercapacitor and a battery at block 27e.

The method 26 may further include conducting a user authentication at block 28, and selectively activating the lock control based on a result of the user authentication at block 29. Some embodiments of the method 26 may further include providing a wireless communications interface to receive authentication input at block 30, visually presenting information associated with the user authentication on a display at block 31, capturing one or more images from a camera at block 32, capturing audio input from an audio device at block 33, and generating the result based on one or more of the authentication input, the one or more images, and the audio input at block 34. For example, the wireless communications interface may include one or more of a WIFI radio, a cellular radio, a BLUETOOTH radio, NFC technology, and SMART CARD technology at block 35.

Some embodiments of the method 26 may further include selectively activating the lock control further based on a state of a capacitive hand monitor at block 36 (e.g., or the result from block 34). For example, the method 26 may include facilitating an exit process without generating a door forced open alarm at block 37. The method 26 may also include converting an analog signal to a digital signal to selectively activate the lock control at block 38.

Embodiments of the method 26 may be implemented in a system, apparatus, computer, device, etc., for example, such as those described herein. More particularly, hardware implementations of the method 26 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 26 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 26 may be implemented on a computer readable medium as described in connection with Examples 20 to 25 below. Embodiments or portions of the method 26 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide an intelligent door controller for security and/or card reader access. Conventional card reader controllers require a hardwired infrastructure and data gathering panels making installation costs very high. Some embodiments may advantageously operate wirelessly and harvest green power to provide a totally self-contained door controller and at a very low price point. For example, a totally standalone intelligent door controller may be built on a low power architecture (e.g., the INTEL ATOM architecture) and provide the capability to support a camera/audio and LCD display all running on a green power source. For example, an LCD display may provide the user with feedback and with the addition of camera (e.g., a REALSENSE camera) and audio, a video call may be initiated (e.g., a SKYPE call). Some embodiments may further include a command library to allow for easy integration to home alarm systems, hotel room doors, etc. Some embodiments may further include a software developer kit (SDK) for commercial applications.

Some embodiments may advantageously reduce or eliminate the need for power, conduit, wire and data gathering panels. For example, through the use of an SDK and wireless connectivity (e.g., WIFI), some embodiments of a door controller may connect natively to an access control server. Some embodiments may harvest green power through the door movement to reduce or eliminate the need for an external power source.

Security card reader controlled doors are ubiquitous. In many environments, card readers may be the standard technology for securing a door. The most recognized door control is probably a hotel room door. Conventionally, the door controller itself is a non-intelligent device which simply recognizes a number within a range that is provisioned to a PVC card or mobile device. Secured access points in commercial applications may be considered semi-intelligent because specific access may be provisioned to an individual and the person-to-reader associations are validated at the point a person attempts to enter the secured area. However, conventional commercial door controllers may require a significant amount of hardware and hardwired infrastructure. For example, a conventional security access control system may require a server, one or more security applications, one or more databases, and one or more data gathering panels that broker data between card reader controlled doors and the server/applications. All or most of the infrastructure is hard wired and the installed cost of a card reader controlled door may be several thousand dollars (e.g., US $). Some installations may not need the data gathering panel(s), but may still require a wired infrastructure with a network cable for power-over-ethernet (POE) as a power source (e.g., and/or batteries that need to be replaced). Some embodiments of an intelligent door controller may provide a fully self-contained door controller (e.g., similar to a hotel room door), but with the built-in intelligence of a commercial security card reader controlled infrastructure. Some embodiments may provide such features without the use of any wiring external to the door. Some embodiments may advantageously utilize green power, and include an LCD screen and a REALSENSE camera. For example, utilizing green power may eliminate any external power source, or may extend the life any included batteries (e.g., reducing how often an included conventional battery needs to be replaced or how often an included rechargeable battery needs to be recharged). Some embodiments may also reduce or eliminate the data gathering hardware used with conventional security access control systems.

In some embodiments, a door controller may communicate natively using 802.11.X wireless technology or GSM directly to the server, thereby eliminating the need for all of the data gathering panels and wired infrastructure (e.g., allowing the device to be connected natively into the IT infrastructure or, through the use of GSM, allowing the device to be deployed at remote locations). Additionally, in some embodiments green power may be harvested at the door through a mechanical induction mechanism and/or a piezoelectric source using the door closer and have power stored using a capacitor and battery tank circuit. In some embodiments, the door controller may be considered as an Internet of Things (IoT) device that may be 100% self-contained at the door and combine the intelligence and controls of a data gathering panel and server data. With suitable technology (e.g., INTEL processors and wireless components), the cost of some embodiments of an intelligent door controller may be cost competitive with the cost of the hardware at the door of a conventional security access control system, while the installation time may be substantially less (e.g., under about two hours per door). On top of the initial installation savings, if a user needs to relocate the door, they can remove the hinge pins and re-install their door in the door frame at their new location vs. install all new hardware at the new location.

Some embodiments may also reduce the complexity to integrate devices into the security ecosystem. For example, some embodiments may provide a very basic command and control library such that the door controller may be quickly and easily integrated to home burglar alarms, hotel doors, custom high-rise buildings, etc., (e.g., suitable for installation by landlords for tenants). Through a more extensive SDK, all device attributes may be exposed by some embodiments for a quick and easy integration to existing commercial/industrial access control solutions.

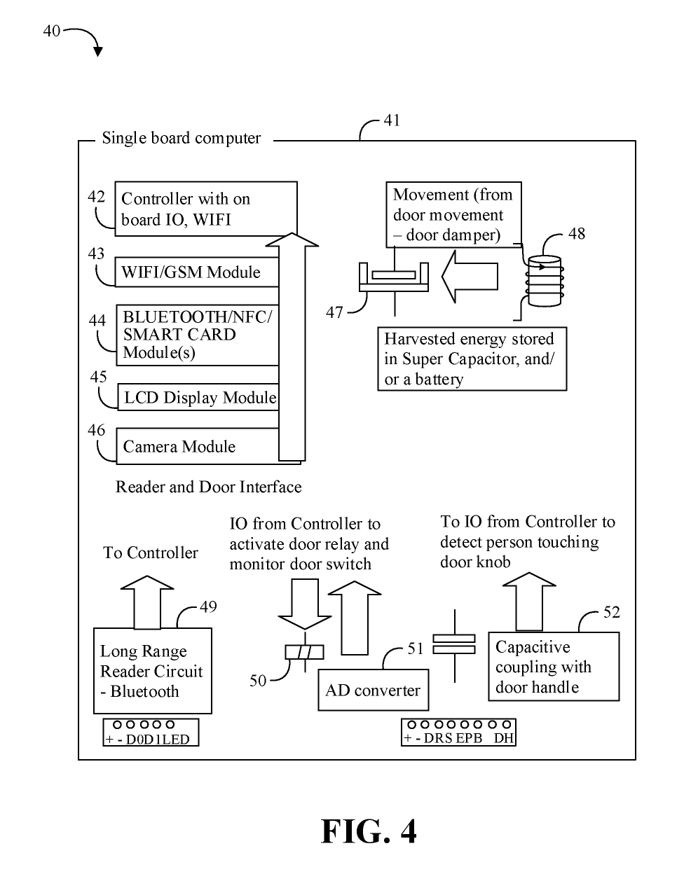

FIG. 4 demonstrates a door control system 40 that eliminates the need for conduit, wire and data gathering panels. The door control system 40 may include a single board computer 41 with various electrical and mechanical components mounted thereon, including a controller 42, a WIFI/GSM module 43, one or more BLUETOOTH/NFC/SMART CARD module(s) 44, a LCD display module 45, and a camera module 46. The door control system 40 may further include a supercapacitor 47 to store energy harvested by an energy harvester 48. Any suitable energy harvesting technology may be utilized for the energy harvester 48 including, for example, kinetic, solar, piezoelectric, revolving coil, etc. The system 40 may further include additional power storage such as a battery. The system 40 may further include a long-range reader circuit 49 (e.g., BLUETOOTH) coupled to the controller 42 (e.g., via a serial port). The system 40 may also include a lock control 50 which selectively locks and unlocks the door. An AD converter 51 may be coupled to the controller 42 and the lock control 50 via IO from the controller 42 to activate the door lock control 50 and monitor the door switch and other analog end points. The system 40 may further include a capacitive coupling 52 with a door handle, coupled through IO with the controller 42 to detect a person touching the door knob to facilitate a request to exit transaction.

Through the use of an SDK and wireless WIFI, some embodiments of the door control system 40 may connect natively to the access control server. Through the door movement (e.g., a door damper), green power may be harvested to eliminate the need for a power source. Thus, the door control system 40 may include the energy harvester 48 and power storage to provide standalone power to the door control system 40, the lock control 50, and a security subsystem (e.g., including the controller 42, the WIFI/GSM module 43, the BLUETOOTH module 44, the LCD display module 45, and the camera module 46) coupled to the lock control 50, the security subsystem to conduct a user authentication and selectively activate the lock control 50 based on a result of the user authentication.

The security subsystem may include a wireless communications interface (e.g., WIFI/GSM module 43, BLUETOOTH/NFC/SMART CARD module(s) 44) to receive authentication input, a display (e.g., LCD display module 45) to visually present information associated with the user authentication, a camera (e.g., camera module 46) to capture one or more images, an audio device to capture audio input, and a processor (e.g., controller 42) to generate the result based on one or more of the authentication input, the one or more images or the audio input.

For example, the wireless communications interface may include one or more of a WIFI radio, a cellular radio, NFC, SMART CARD or a BLUETOOTH radio. In one example, the door control system 40 further includes a capacitive hand monitor (e.g., capacitive coupling 52) coupled to the security subsystem, wherein the security subsystem is to selectively activate the lock control 50 further based on a state of the capacitive hand monitor. Moreover, the door control system 40 may further include the supercapacitor 47 coupled to the energy harvester and an analog-to-digital (AD) converter 51 coupled to the lock control, other analog end points 50 and the security subsystem.

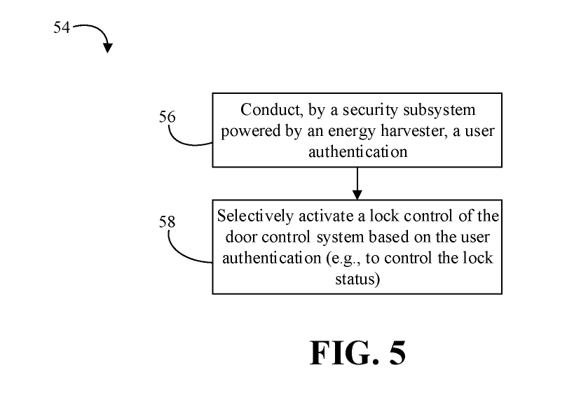

FIG. 5 shows a method 54 of operating a security subsystem. The method 54 may generally be implemented in a processor of a door control system such as, for example, the door control system 10 (FIG. 1) and/or the door control system 40 (FIG. 4), already discussed. More particularly, the method 54 may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 54 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 56 conducts, by a security subsystem powered by an energy harvester, a user authentication. Block 58 may selectively activate a lock control of the door control subsystem based on the user authentication (e.g., to control the lock status).

Inbound Access Control Example

For inbound access control, a credential is passed to the reader. The carrier (e.g., badge, smartphone, etc.) has a key provisioned that matches the key of the reader to establish communications. When the credential is read by the reader, conventionally that number string is passed to the data gathering panel (DGP) where the number string checked in local memory. If the number string resides locally, the command is sent from the DGP to the lock control to unlock the door. Advantageously, some embodiments may eliminate a separate DGP and the intelligent lock may act as the DGP. For example, the credential may be checked in local memory of the intelligent door controller to see if access should be granted and, if so, the intelligent door controller may cause the lock control to unlock the door. If the credential is not in local memory, the intelligent door controller may pass the credential to a server/database (DB) to retrieve access permission. If the credential passed to the DB has access, the intelligent door controller may cause the lock control to unlock the door.

On a granted transaction the door status switch may be shunted so a door forced open alarm is not sent in. Also, a timer may be set to a pre-determined duration and if the door is not opened when the duration expires the door may relock. When the door is opened, the door status switch changes state and the door relocks so it is secure when it closes. Also, a timer may be set to a pre-determined duration and if the door is not closed when the duration expires a door held open alarm may be raised. When the door is closed, the door status switch may sense the closed state and if the door is opened without an authorized inbound or outbound transaction the intelligent door controller may send in a door forced open alarm.

Outbound Access Control Examples

For outbound access control, a request to exit (REX) may be sent to the intelligent door controller (e.g., via a motion sensor, a pushbutton or some other switch). For example, a request to exit may correspond to an open switch that goes to a closed status momentarily. When a REX is sent from the door, conventionally that contact change of state is passed to the DGP where it starts the outbound exit process the command is sent from the DGP to the lock control to unlock the door. Some embodiments may advantageously eliminate a separate DGP and the intelligent door controller may act as the DGP. For example, the REX may correspond to a capacitance read at the door knob (e.g., someone's hand on the knob or lever) and the intelligent door controller may cause the lock control to unlock the door.

On a REX transaction, the door status switch is shunted so a door forced open alarm is not sent in. Also, a timer may be set to a pre-determined duration and if the door is not opened when the duration expires the door relocks. When the door is opened the door status switch changes state and the door relocks so it is secure when it closes. Also, a timer may be set to a pre-determined duration and if the door is not closed when the duration expires a door held open alarm is raised. When the door is closed, the state may be sensed by the door status switch and if the door is opened without an authorized inbound or outbound transaction the door will send in a door forced open alarm.

Automated Security Attendant Examples

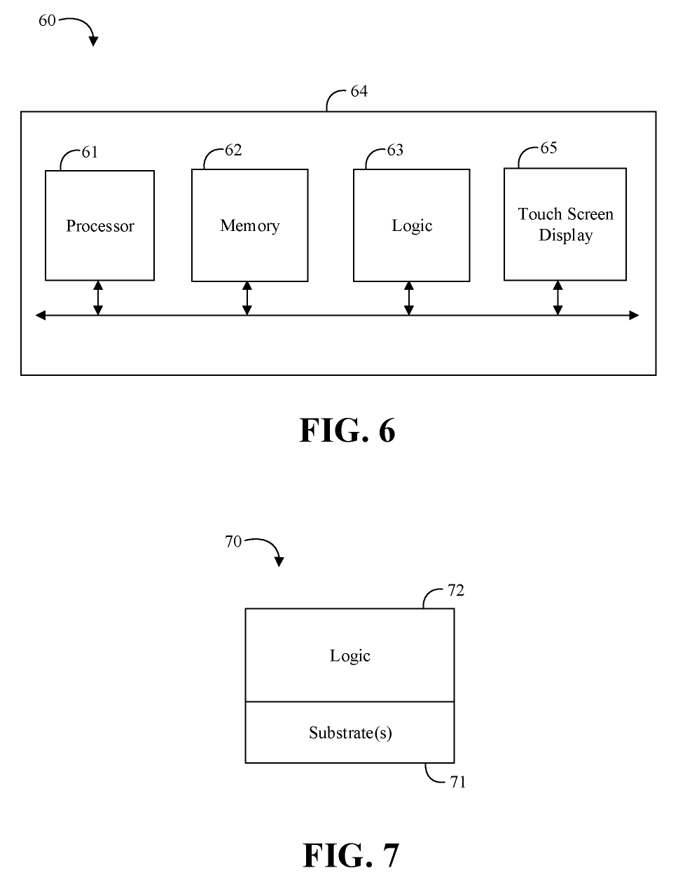

Turning now to FIG. 6, an embodiment of an automated security attendant system 60 may include a processor 61, memory 62 communicatively coupled to the processor 61, and logic 63 communicatively coupled to the processor 61 to provide an interface for a user to authenticate themself with secondary information, authenticate the user based on user input of the secondary information, and provide temporary access to an access control system based on the authentication of the user. For example, the user may not have their primary identification information (e.g., an ID badge), but the automated security attendant system 60 may allow the user to provide secondary information to gain access to the facilities. Any suitable secondary information may be utilized for the user authentication including, for example, a username/password (e.g., Active Directory), a secondary ID (e.g., driver's license, passport, etc.), biometric information (e.g., a fingerprint, a hand print, iris recognition, facial recognition, voice recognition, etc.), a verification code sent to a user device (e.g., a text message sent to the user's cell phone number on file), etc.

In some embodiments, the logic 63 may be further configured to issue a temporary access badge to the user based on the authentication of the user. The logic 63 may also be configured to provide an interface for a guest to register, register the guest based on guest input, and automatically provide notice to one or more users following the registration of the guest. In some embodiments, the logic 63 may also include technology to provide a video call to a pre-determined recipient. For example, the system 60 may further include a kiosk 64 to house the processor 61, memory 62, and logic 63, and a touch screen display 65 affixed to the kiosk 64 and communicatively coupled to the processor 61 to provide one or more of the user interface, the guest interface, and the video call.

Embodiments of each of the above processor 61, memory 62, logic 63, touch screen display 65, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, memory 62, persistent storage media or other system memory may store a set of instructions which when executed by the processor 61 cause the system 60 to implement one or more components, features, or aspects of the system 60 (e.g., the logic 63, provide the user interface, authenticating the user based on user input of the secondary information, providing temporary access to the access control system based on the authentication of the user, etc.).

Turning now to FIG. 7, an embodiment of a semiconductor package apparatus 70 may include one or more substrates 71, and logic 72 coupled to the one or more substrates 71, wherein the logic 72 is at least partly implemented in one or more of configurable logic and fixed-functionality hardware logic. The logic 72 coupled to the one or more substrates 71 may be configured to provide an interface for a user to authenticate themself with secondary information, authenticate the user based on user input of the secondary information, and provide temporary access to an access control system based on the authentication of the user. In some embodiments, the logic 72 may be further configured to issue a temporary access badge to the user based on the authentication of the user. The logic 72 may also be configured to provide an interface for a guest to register, register the guest based on guest input, and automatically provide notice to one or more users following the registration of the guest. In some embodiments, the logic 72 may also be configured to provide a video call to a pre-determined recipient, and/or to provide a touch screen display interface for one or more of the user interface, the guest interface, and the video call. In some embodiments, the logic 72 coupled to the one or more substrates 71 may include transistor channel regions that are positioned within the one or more substrates 71.

Embodiments of logic 72, and other components of the apparatus 70, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

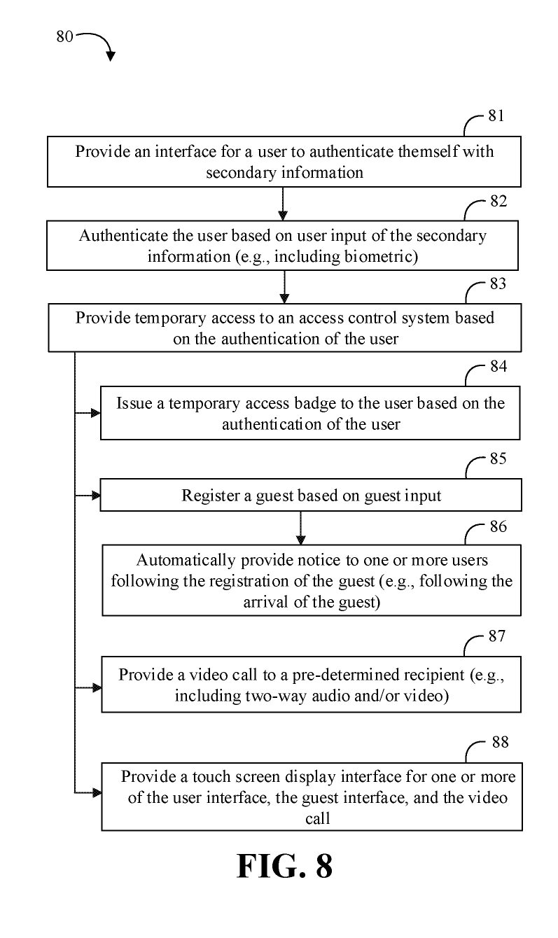

The apparatus 70 may implement one or more aspects of the method 80 (FIG. 8 or any of the embodiments discussed herein. In some embodiments, the illustrated apparatus 70 may include the one or more substrates 71 (e.g., silicon, sapphire, gallium arsenide) and the logic 72 (e.g., transistor array and other integrated circuit/IC components) coupled to the substrate(s) 71. The logic 72 may be implemented at least partly in configurable logic or fixed-functionality logic hardware. In one example, the logic 72 may include transistor channel regions that are positioned (e.g., embedded) within the substrate(s) 71. Thus, the interface between the logic 72 and the substrate(s) 71 may not be an abrupt junction. The logic 72 may also be considered to include an epitaxial layer that is grown on an initial wafer of the substrate(s) 71.

Turning now to FIG. 8, an embodiment of a method 80 of automatically attending to security screening may include providing an interface for a user to authenticate themself with secondary information at block 81 (e.g., including biometric information), authenticating the user based on user input of the secondary information at block 82, and providing temporary access to an access control system based on the authentication of the user at block 83. For example, the method 80 may include issuing a temporary access badge to the user based on the authentication of the user at block 84. The method 80 may also include registering a guest based on guest input at block 85, and automatically providing notice to one or more users following the registration of the guest at block 86 (e.g., following the arrival of the guest). In some embodiments, the method 80 may further include providing a video call to a pre-determined recipient at block 87 (e.g., a two-way video call), and/or providing a touch screen display interface for one or more of the user interface, the guest interface, and the video call at block 88.

Embodiments of the method 80 may be implemented in a system, apparatus, computer, device, etc., for example, such as those described herein. More particularly, hardware implementations of the method 80 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 80 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 80 may be implemented on a computer readable medium as described in connection with Examples 48 to 52 below. Embodiments or portions of the method 80 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide a security automated attendant. As businesses have struggled to balance their tight budgets they are becoming more willing to assume a higher level of risk and less controls at their facility entry points. Individuals entering through an unstaffed, secured location do not have the same services available to them as they do at a staffed location i.e. temporary badge issuance, guest services, delivery, request assistance, contact someone, etc. These unstaffed entry points may be semi-secured with card readers using the honor system of who enters once the door is unlocked. Or, they may include a higher level of security with tighter controls using revolving doors or turnstiles. Regardless of the chosen solution, this creates the dilemma of how to manage an individual who has forgotten or lost their badge. Should the individual have to walk to a staffed location or should they be allowed to tail-gate in behind someone else and hope that they walk to staffed location to get a temporary badge? At a minimum this creates a customer inconvenience, but more importantly it creates an opportunity for unauthorized access to an individual with nefarious intentions easy access to a facility. Additionally, how does the business manage guest access and deliveries that usually occur only at a staffed entry point?

Some embodiments may advantageously provide security services at unstaffed entrances with an automated attendant. In some embodiments, the automated attendant may be a multifunction kiosk that may manage temporary badge issuance and return, guest visit registration and guest arrival notification, and provide the ability to contact employees, request assistance via a video call session (e.g., SKYPE), and to allow delivery people to make deliveries. Any suitable technology may be utilized to construct some embodiments of an automated attendant (e.g., off-the-shelf kiosk hardware) and software may be configured to leverage Active Directory and/or provide integration to the security access control system (e.g., badges and card readers). Some embodiments may provide a fully automated self-service solution providing functionality previously only available at staffed locations.

In some embodiments, an individual may authenticate themself through an Active Directory single sign on. Following such authentication, a connection to the security system may issue an activated temporary employee or contingent worker badge through the kiosk. Through a similar validation, in some embodiments an individual may register a guest in a guest registration module. Once a guest is registered, the guest may sign in at the automated attendant to announce their arrival and have a guest badge issued to themself. Some embodiments may provide a directory that can be opted into by the employees. The kiosk may then display names of individuals in the directory that can be contacted by selecting an icon (e.g., no numbers may be displayed). Selecting the icon may initiate contact through the selected person's desk phone or via cell phone. A selection may also be provided to get assistance (e.g., a “Get Assistance” icon), where a video call session may be established with security to provide assistance. In some embodiments, a selection to make contact may also be provided (e.g., a “Make Contact” icon) to allow delivery people to make a delivery.

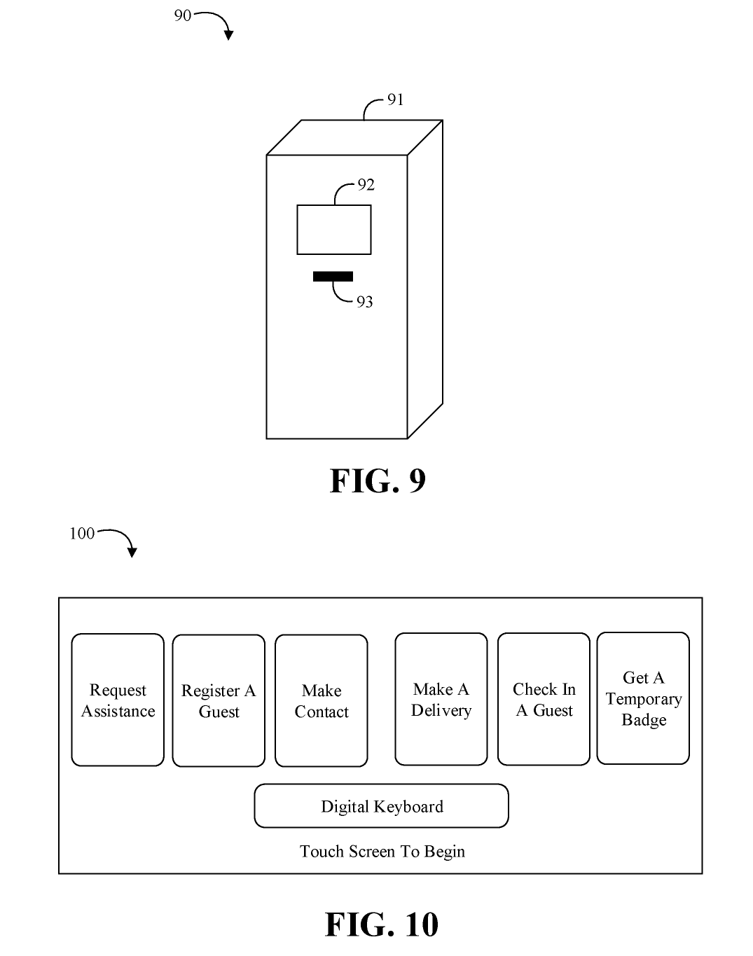

Turning now to FIG. 9, an embodiment of an automated security attendant 90 may include a kiosk 91 with suitable electronic and mechanical technology (e.g., a multi-hopper badge dispenser) inside the kiosk 91. The kiosk 91 may include a touch screen display 92 and a slot 93 to dispense badges. For example, the kiosk 91 may include technology to manage temporary badge issuance and return, to manage guest visit registration and guest arrival notification, to contact employees, to request assistance via a video call session, and to allow delivery people to make deliveries.

Turning now to FIG. 10, an embodiment of an illustrative user interface 100 may include a touch screen display interface where the user may touch a desired selection on a display to cause the automated security attendant to execute the requested selection. Non-limiting examples of selections provided by the user interface 100 may include a “Request Assistance” icon, a “Register A Guest” icon, a “Make Contact” icon, a “Make A Delivery” icon, a “Check In A Guest” icon, and a “Get A Temporary Badge” icon. Selecting an icon may launch a digital keyboard for doing data entry. Those skilled in the art will appreciate that more or fewer icons may be provided, that different arrangements of such icons may be provided, and that such icons may include graphical images in addition to or instead of text.

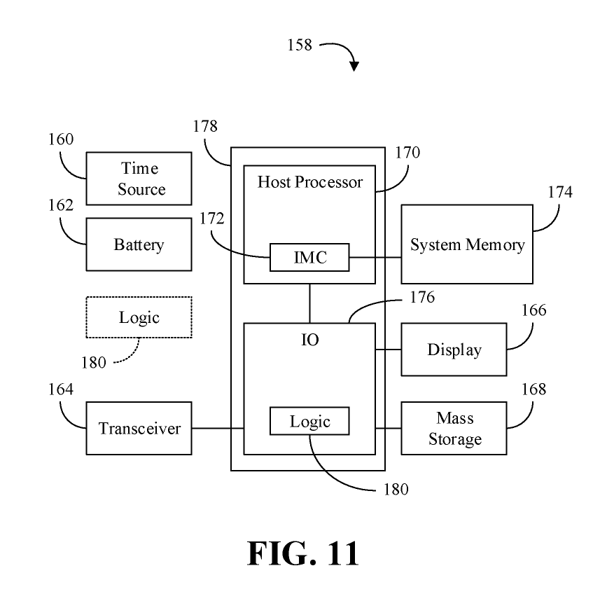

FIG. 11 shows a computing device 158 that may be readily substituted for or utilized by one or more of the door control systems 10 (FIGS. 1) and 40 (FIG. 4), and/or the automated security attendants 60 (FIGS. 6) and 90 (FIG. 9), already discussed. In the illustrated example, the device 158 includes a time source 160 (e.g., crystal oscillator, clock), a battery 162 to supply power to the device 158, a transceiver 164 (e.g., wireless or wired), a display 166 and mass storage 168 (e.g., hard disk drive/HDD, solid state disk/SSD, optical disk, flash memory). The device 158 may also include a host processor 170 (e.g., CPU) having an integrated memory controller (IMC) 172, which may communicate with system memory 174. The system memory 174 may include, for example, dynamic random access memory (DRAM) configured as one or more memory modules such as, for example, dual inline memory modules (DIMMs), small outline DIMMs (SODIMMs), etc. The illustrated device 158 also includes an input output (10) module 176 implemented together with the processor 170 on a semiconductor die 178 as a system on chip (SoC), wherein the IO module 176 functions as a host device and may communicate with, for example, the display 166, the transceiver 164, the mass storage 168, and so forth. The mass storage 168 may include non-volatile memory (NVM) that stores one or more keys (e.g., MAC generation keys, encryption keys).

The IO module 176 may include logic 180 that causes the semiconductor die 178 to operate as a door controller such as, for example, the door control systems 10 (FIGS. 1) and 40 (FIG. 4), and/or as an automated security attendant such as, the automated security attendants 60 (FIGS. 6) and 90 (FIG. 9). Thus, the logic 180 may conduct a user authentication, and selectively activate a lock control based on a result of the user authentication. In some embodiments, the logic 180 may be further configured to provide a wireless communications interface to receive authentication input, visually present information associated with the user authentication on a display, capture one or more images from a camera, capture audio input from an audio device, and generate the result based on one or more of the authentication input, the one or more images, and the audio input.

Moreover, the logic 180 may alternatively, or additionally, provide an interface for a user to authenticate themself with secondary information, authenticate the user based on user input of the secondary information, and provide temporary access to an access control system based on the authentication of the user. In one example, the time source 160 is autonomous/independent from the controller in order to enhance security (e.g., to prevent the controller from tampering with cadence, frequency, latency and/or timestamp data). The logic 180 may also be implemented elsewhere in the device 158.

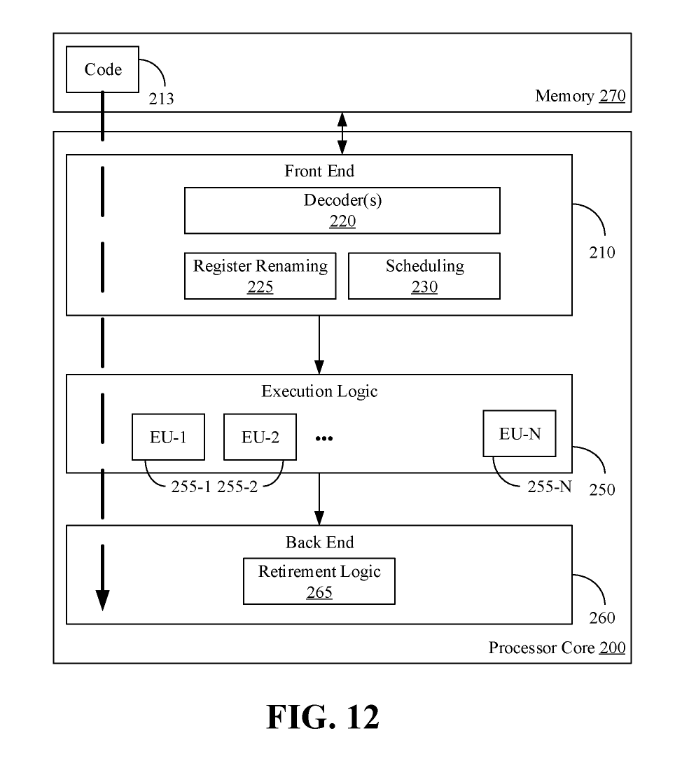

FIG. 12 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 12, a processing element may alternatively include more than one of the processor core 200 illustrated in FIG. 12. The processor core 200 may be a single-threaded core or, for at least one embodiment, the processor core 200 may be multithreaded in that it may include more than one hardware thread context (or “logical processor”) per core.

FIG. 12 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 26 (FIGS. 3A to 3D), the method 54, and/or the method 80, already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 12, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

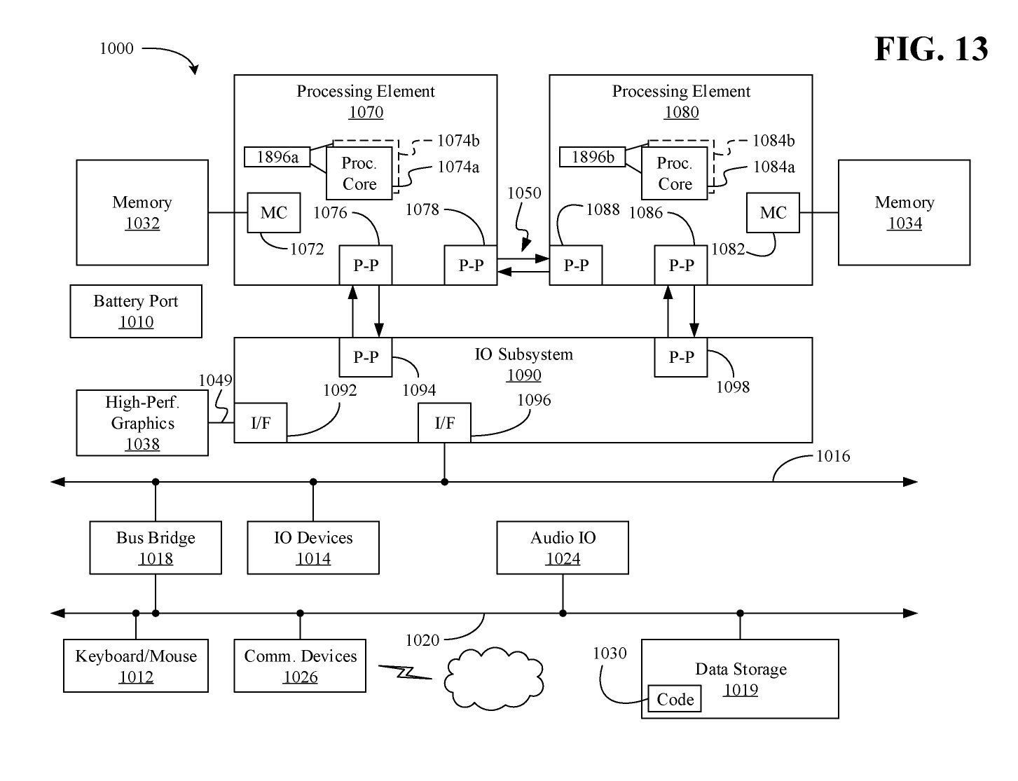

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 26 (FIGS. 3A to 3D), the method 54, and/or the method 80, already discussed, and may be similar to the code 213 (FIG. 12), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

Additional Notes and Examples:

Example 1 may include a door control system, comprising an energy harvester to provide standalone power to the door control system, a lock control, and a security subsystem coupled to the lock control, the security subsystem to conduct a user authentication and selectively activate the lock control based on a result of the user authentication.

Example 2 may include the system of Example 1, wherein the security subsystem includes a wireless communications interface to receive authentication input, a display to visually present information associated with the user authentication, a camera to capture one or more images, an audio device to capture audio input, and a processor to generate the result based on one or more of the authentication input, the one or more images or the audio input.

Example 3 may include the system of Example 2, wherein the wireless communications interface includes one or more of a WIFI radio, a cellular radio, and a BLUETOOTH radio.

Example 4 may include the system of any of Examples 1 to 3, further including a capacitive hand monitor coupled to the security subsystem, wherein the security subsystem is to selectively activate the lock control further based on a state of the capacitive hand monitor.

Example 5 may include the system of any of Examples 1 to 3, further including a supercapacitor coupled to the energy harvester.

Example 6 may include the system of any of Examples 1 to 3, further including an analog-to-digital converter coupled to the lock control and the security subsystem.

Example 7 may include a door controller apparatus, comprising an energy harvester to provide power, one or more substrates, and logic coupled to the one or more substrates and the energy harvester, wherein the logic is at least partly implemented in one or more of configurable logic and fixed-functionality hardware logic, the logic coupled to the one or more substrates to conduct a user authentication, and selectively activate a lock control based on a result of the user authentication.

Example 8 may include the apparatus of Example 7, wherein the logic is further to provide a wireless communications interface to receive authentication input, visually present information associated with the user authentication on a display, capture one or more images from a camera, capture audio input from an audio device, and generate the result based on one or more of the authentication input, the one or more images, and the audio input.

Example 9 may include the apparatus of Example 8, wherein the wireless communications interface includes one or more of a WIFI radio, a cellular radio, and a BLUETOOTH radio.

Example 10 may include the apparatus of any of Examples 7 to 9, wherein the logic is further to selectively activate the lock control further based on a state of a capacitive hand monitor.

Example 11 may include the apparatus of any of Examples 7 to 9, further including a supercapacitor coupled to the energy harvester.

Example 12 may include the apparatus of any of Examples 7 to 9, wherein the logic is further to convert an analog signal to a digital signal to selectively activate the lock control.

Example 13 may include the apparatus of any of Examples 7 to 12, wherein the logic coupled to the one or more substrates includes transistor channel regions that are positioned within the one or more substrates.

Example 14 may include a method of controlling a door, comprising harvesting energy to provide power to a lock control, conducting a user authentication and selectively activating the lock control based on a result of the user authentication.

Example 15 may include the method of Example 14, further comprising providing a wireless communications interface to receive authentication input, visually presenting information associated with the user authentication on a display, capturing one or more images from a camera, capturing audio input from an audio device, and generating the result based on one or more of the authentication input, the one or more images, and the audio input.

Example 16 may include the method of Example 15, wherein the wireless communications interface includes one or more of a WIFI radio, a cellular radio, and a BLUETOOTH radio.

Example 17 may include the method of any of Examples 14 to 16, further comprising selectively activating the lock control further based on a state of a capacitive hand monitor.

Example 18 may include the method of any of Examples 14 to 16, further comprising storing harvested energy in a supercapacitor.

Example 19 may include the method of any of Examples 14 to 16, further comprising converting an analog signal to a digital signal to selectively activate the lock control.

Example 20 may include at least one computer readable storage medium, comprising a set of instructions, which when executed by a computing device, cause the computing device to harvest energy to provide power to a lock control, conduct a user authentication and selectively activate the lock control based on a result of the user authentication.

Example 21 may include the at least one computer readable storage medium of Example 20, comprising a further set of instructions, which when executed by the computing device, cause the computing device to provide a wireless communications interface to receive authentication input, visually present information associated with the user authentication on a display, capture one or more images from a camera, capture audio input from an audio device, and generate the result based on one or more of the authentication input, the one or more images, and the audio input.

Example 22 may include the at least one computer readable storage medium of Example 21, wherein the wireless communications interface includes one or more of a WIFI radio, a cellular radio, and a BLUETOOTH radio.

Example 23 may include the at least one computer readable storage medium of any of Examples 20 to 22, comprising a further set of instructions, which when executed by the computing device, cause the computing device to selectively activate the lock control further based on a state of a capacitive hand monitor.

Example 24 may include the at least one computer readable storage medium of any of Examples 20 to 22, comprising a further set of instructions, which when executed by the computing device, cause the computing device to store harvested energy in a supercapacitor.

Example 25 may include the at least one computer readable storage medium of any of Examples 20 to 22, comprising a further set of instructions, which when executed by the computing device, cause the computing device to convert an analog signal to a digital signal to selectively activate the lock control.

Example 26 may include a door controller apparatus, comprising means for harvesting energy to provide power to a lock control, means for conducting a user authentication and means for selectively activating the lock control based on a result of the user authentication.

Example 27 may include the apparatus of Example 26, further comprising means for providing a wireless communications interface to receive authentication input, means for visually presenting information associated with the user authentication on a display, means for capturing one or more images from a camera, means for capturing audio input from an audio device, and means for generating the result based on one or more of the authentication input, the one or more images, and the audio input.

Example 28 may include the apparatus of Example 27, wherein the wireless communications interface includes one or more of a WIFI radio, a cellular radio, and a BLUETOOTH radio.

Example 29 may include the apparatus of any of Examples 26 to 28, further comprising means for selectively activating the lock control further based on a state of a capacitive hand monitor.

Example 30 may include the apparatus of any of Examples 26 to 28, further comprising means for storing harvested energy in a supercapacitor.

Example 31 may include the apparatus of any of Examples 26 to 28, further comprising means for converting an analog signal to a digital signal to selectively activate the lock control.

Example 32 may include an automated security attendant system, comprising a processor, memory communicatively coupled to the processor, and logic communicatively coupled to the processor to provide an interface for a user to authenticate themself with secondary information, authenticate the user based on user input of the secondary information, and provide temporary access to an access control system based on the authentication of the user.

Example 33 may include the system of Example 32, wherein the logic is further to issue a temporary access badge to the user based on the authentication of the user.

Example 34 may include the system of Example 32, wherein the logic is further to provide an interface for a guest to register, register the guest based on guest input, and automatically provide notice to one or more users following the registration of the guest.

Example 35 may include the system of Example any of Examples 32 to 34, wherein the logic is further to provide a video call to a pre-determined recipient.

Example 36 may include the system of any of Examples 32 to 35, further comprising a kiosk to house the processor, memory, and logic, and a touch screen display affixed to the kiosk and communicatively coupled to the processor to provide one or more of the user interface, the guest interface, and the video call.

Example 37 may include a semiconductor package apparatus, comprising one or more substrates, and logic coupled to the one or more substrates, wherein the logic is at least partly implemented in one or more of configurable logic and fixed-functionality hardware logic, the logic coupled to the one or more substrates to provide an interface for a user to authenticate themself with secondary information, authenticate the user based on user input of the secondary information, and provide temporary access to an access control system based on the authentication of the user.

Example 38 may include the apparatus of Example 37, wherein the logic is further to issue a temporary access badge to the user based on the authentication of the user.

Example 39 may include the apparatus of Example 37, wherein the logic is further to provide an interface for a guest to register, register the guest based on guest input, and automatically provide notice to one or more users following the registration of the guest.

Example 40 may include the apparatus of Example any of Examples 37 to 39, wherein the logic is further to provide a video call to a pre-determined recipient.

Example 41 may include the apparatus of any of Examples 37 to 40, wherein the logic is further to provide a touch screen display interface for one or more of the user interface, the guest interface, and the video call.

Example 42 may include the apparatus of any of Examples 37 to 41, wherein the logic coupled to the one or more substrates includes transistor channel regions that are positioned within the one or more substrates.

Example 43 may include a method of automatically attending to security screening, comprising providing an interface for a user to authenticate themself with secondary information, authenticating the user based on user input of the secondary information, and providing temporary access to an access control system based on the authentication of the user.

Example 44 may include the method of Example 43, further comprising issuing a temporary access badge to the user based on the authentication of the user.

Example 45 may include the method of Example 43, further comprising registering the guest based on guest input, and automatically providing notice to one or more users following the registration of the guest.

Example 46 may include the method of Example any of Examples 43 to 45, further comprising providing a video call to a pre-determined recipient.

Example 47 may include the method of any of Examples 43 to 46, further comprising providing a touch screen display interface for one or more of the user interface, the guest interface, and the video call.

Example 48 may include at least one computer readable storage medium, comprising a set of instructions, which when executed by a computing device, cause the computing device to provide an interface for a user to authenticate themself with secondary information, authenticate the user based on user input of the secondary information, and provide temporary access to an access control system based on the authentication of the user.

Example 49 may include the at least one computer readable storage medium of Example 48, comprising a further set of instructions, which when executed by the computing device, cause the computing device to issue a temporary access badge to the user based on the authentication of the user.

Example 50 may include the at least one computer readable storage medium of Example 48, comprising a further set of instructions, which when executed by the computing device, cause the computing device to register the guest based on guest input, and automatically provide notice to one or more users following the registration of the guest.

Example 51 may include the at least one computer readable storage medium of any of Examples 48 to 50, comprising a further set of instructions, which when executed by the computing device, cause the computing device to provide a video call to a pre-determined recipient.

Example 52 may include the at least one computer readable storage medium of any of Examples 48 to 51, comprising a further set of instructions, which when executed by the computing device, cause the computing device to provide a touch screen display interface for one or more of the user interface, the guest interface, and the video call.

Example 53 may include an automated security attendant apparatus, comprising means for providing an interface for a user to authenticate themself with secondary information, means for authenticating the user based on user input of the secondary information, and means for providing temporary access to an access control system based on the authentication of the user.

Example 54 may include the apparatus of Example 53, further comprising means for issuing a temporary access badge to the user based on the authentication of the user.

Example 55 may include the apparatus of Example 53, further comprising means for registering the guest based on guest input, and means for automatically providing notice to one or more users following the registration of the guest.

Example 56 may include the apparatus of Example any of Examples 53 to 55, further comprising means for providing a video call to a pre-determined recipient.

Example 57 may include the apparatus of any of Examples 53 to 56, further comprising means for providing a touch screen display interface for one or more of the user interface, the guest interface, and the video call.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A door control system, comprising:
an energy harvester and power storage to provide standalone power to the door control system;
a lock control to control a lock;
a contact to determine a state of a door; and
a security subsystem coupled to the lock control, the security subsystem to conduct a user authentication and selectively activate the lock control based on a result of the user authentication.

2. The system of claim 1, wherein the security subsystem includes:
a wireless communications interface to receive authentication input;
a display to visually present information associated with the user authentication;
a camera to capture one or more images;
an audio device to capture audio input; and
a processor to generate the result based on one or more of the authentication input, the one or more images or the audio input.

3. The system of claim 2, wherein the wireless communications interface includes one or more of a WIFI radio, a cellular radio, a BLUETOOTH radio, Near Field Communication technology, and SMART CARD technology.

4. The system of claim 1, wherein the power storage includes one or more of a supercapacitor and a battery coupled to the energy harvester.

5. The system of claim 1, further including a capacitive hand monitor coupled to the security subsystem, to facilitate an exit process without generating a door forced open alarm, wherein the security subsystem is to selectively activate the lock control further based on a state of the capacitive hand monitor.

6. The system of claim 1, further including an analog-to-digital converter coupled to the lock control and the security subsystem.

7. A door controller apparatus, comprising:
an energy harvester and power storage to provide power;
one or more substrates; and
logic coupled to the one or more substrates and the power storage, wherein the logic is at least partly implemented in one or more of configurable logic and fixed- functionality hardware logic, the logic coupled to the one or more substrates to:
conduct a user authentication, and
selectively activate a lock control based on a result of the user authentication.

8. The apparatus of claim 7, wherein the logic is further to:
provide a wireless communications interface to receive authentication input;
visually present information associated with the user authentication on a display;
capture one or more images from a camera;
capture audio input from an audio device; and
generate the result based on one or more of the authentication input, the one or more images, and the audio input.

9. The apparatus of claim 8, wherein the wireless communications interface includes one or more of a WIFI radio, a cellular radio, a BLUETOOTH radio, Near Field Communication technology, and SMART CARD technology.

10. The apparatus of claim 7, wherein the power storage includes one or more of a supercapacitor and a battery coupled to the energy harvester.

11. The apparatus of claim 7, wherein the logic is further to:
selectively activate the lock control further based on a state of a capacitive hand monitor, to facilitate an exit process without generating a door forced open alarm.

12. The apparatus of claim 7, wherein the logic is further to:
convert an analog signal to a digital signal to selectively activate the lock control.

13. The apparatus of claim 7, wherein the logic coupled to the one or more substrates includes transistor channel regions that are positioned within the one or more substrates.

14. A method of controlling a door, comprising:
harvesting energy, storing the harvested energy, and providing the stored power to a lock control;
conducting a user authentication; and
selectively activating the lock control based on a result of the user authentication.

15. The method of claim 14, further comprising:
providing a wireless communications interface to receive authentication input;
visually presenting information associated with the user authentication on a display;
capturing one or more images from a camera;
capturing audio input from an audio device; and
generating the result based on one or more of the authentication input, the one or more images, and the audio input.

16. The method of claim 15, wherein the wireless communications interface includes one or more of a WIFI radio, a cellular radio, a BLUETOOTH radio, Near Field Communication technology, and SMART CARD technology.

17. The method of claim 14, further comprising:
storing harvested energy in one or more of a supercapacitor and a battery.

18. The method of claim 14, further comprising:
selectively activating the lock control further based on a state of a capacitive hand monitor; and
facilitating an exit process without generating a door forced open alarm.

19. The method of claim 14, further comprising:
converting an analog signal to a digital signal to selectively activate the lock control.

20. At least one computer readable storage medium, comprising a set of instructions, which when executed by a computing device, cause the computing device to:
harvest energy, store the harvested energy, and provide the stored power to a lock control;
conduct a user authentication; and
selectively activate the lock control based on a result of the user authentication.

21. The at least one computer readable storage medium of claim 20, comprising a further set of instructions, which when executed by the computing device, cause the computing device to:
provide a wireless communications interface to receive authentication input;
visually present information associated with the user authentication on a display;
capture one or more images from a camera;
capture audio input from an audio device; and
generate the result based on one or more of the authentication input, the one or more images, and the audio input.

22. The at least one computer readable storage medium of claim 21, wherein the wireless communications interface includes one or more of a WIFI radio, a cellular radio, a BLUETOOTH radio, Near Field Communication technology, and SMART CARD technology.

23. The at least one computer readable storage medium of claim 20, comprising a further set of instructions, which when executed by the computing device, cause the computing device to:
store harvested energy in one or more of a supercapacitor and a battery.

24. The at least one computer readable storage medium of claim 20, comprising a further set of instructions, which when executed by the computing device, cause the computing device to:
selectively activate the lock control further based on a state of a capacitive hand monitor and
facilitate an exit process without generating a door forced open alarm.

25. The at least one computer readable storage medium of claim 20, comprising a further set of instructions, which when executed by the computing device, cause the computing device to:
convert an analog signal to a digital signal to selectively activate the lock control.
